(19) United States
(12) Patent Application Publication
(10) Pub. No.: US 2011/0150119 A1
(43) Pub. Date: Jun. 23, 2011

(54) METHOD AND SYSTEM FOR CHANNEL ESTIMATION IN AN OFDM BASED MIMO SYSTEM

(76) Inventors: Mark Kent, Vista, CA (US); Vinko Erceg, Cardiff, CA (US)

(21) Appl. No.: 12/756,300

(22) Filed: Apr. 8, 2010

Related U.S. Application Data
(60) Provisional application No. 61/288,258, filed on Dec. 18, 2009.

(51) Int. Cl. H04B 7/02; H04L 27/08

(52) U.S. Cl. 375/267; 375/345

(57) ABSTRACT

Upon receiving spatially independent OFDM signals from multiple transmit antennas coupled to a single transmitter, a receiver comprising multiple receive antennas operably coupled to multiple RF chains adjusts phase and/or gain of a portion of signal components received over multiple receive antennas coupled to the same RF chain. A combined channel estimate for the RF chain is generated using corresponding frequency domain samples of the adjusted signal components. Individual channel estimates are generated from the generated combined channel estimate. Phase rotation and/or gain adjustment information are determined to adjust signal components received over additional receive antennas coupled to the RF chain. The phase and/or gain adjusted signal components are combined with signal components over a selected reference receive antenna coupled to the RF chain for RF processing. The RF processed signal components are converted into corresponding frequency domain samples to generate individual channel estimates for the phase rotation and/or gain adjustment.

### CROSS-REFERENCE TO RELATED APPLICATIONS/INCORPORATION BY REFERENCE

This patent application makes reference to, claims priority to and claims the benefit from U.S. Provisional Patent Application Ser. No. 61/288,258 filed on Dec. 18, 2009.

This application makes reference to:
U.S. application Ser. No. 11/173,964 (Attorney Docket No. 16203US02) filed on Jun. 30, 2005; and
U.S. application Ser. No. 11/172,756 (Attorney Docket No. 16206US02) filed on Jun. 30, 2005.

Each of the above stated applications is hereby incorporated herein by reference in its entirety.

### FIELD OF THE INVENTION

Certain embodiments of the invention relate to signal processing for communication systems. More specifically, certain embodiments of the invention relate to a method and system for channel estimation in an OFDM based MIMO system.

### BACKGROUND OF THE INVENTION

Wireless communication systems are widely deployed to provide various types of communications such as voice and data for a number of associated users. These systems may be implemented based on various access techniques such as, for example, code division multiple access (CDMA), time division multiple access (TDMA), frequency division multiple access (FDMA), or some other multiple access techniques to transmit and/or receive data traffic over communication channels. A communication channel is characterized by fluctuating signal levels and additive interference from in-cell and outer-cells. Signals transmitted over a communication channel exhibit Inter-Path Interference (IPI) and fading, which directly affect the communicated signals and result in time-varying signal quality such as varying signal to interference plus noise power ratio (SINR). Special means such as, for example, Orthogonal Frequency Division Multiplexing (OFDM) and/or Multiple-Input-Multiple-Output (MIMO) communication, may be utilized so as to combat these effects and provide reliable communications. OFDM is a frequency-division multiplexing (FDM) scheme utilized as a digital multi-carrier modulation method.

A MIMO communication system employs multiple transmit (N_{T}) antennas and multiple receive (N_{R}) antennas for communicating multiple spatially independent data streams. A MIMO channel is formed by multiple transmit (N_{T}) antennas and multiple receive (N_{R}) antennas. A MIMO channel may be implemented as a single user MIMO channel or a multi-user MIMO channel. A single user MIMO channel is formed through a point to point connection from a multiple-antenna transmitter such as a base station with multiple transmit (N_{T}) antennas to a single multiple-antenna receiver such as a mobile device with multiple receive (N_{R}) antennas. A multi-user MIMO channel is formed through a multipoint to point and/or point to multipoint connections. A multi-user MIMO channel over a multipoint to point connection is formed via multiple transmit (N_{T}) antennas located on multiple transmitters and multiple receive (N_{R}) antennas on a single multiple-antenna receiver. A multi-user MIMO channel over a single point to multipoint connection is formed via multiple transmit (N_{T}) antennas located on a single transmitter and multiple receive (N_{R}) antennas on multiple receivers.

Signals received over a communication channel such as a MIMO channel may be processed using radio frequency (RF) processing paths or RF chains for further baseband processing. A RF chain or a RF processing path comprises, for example, a low noise amplifier (LNA), a low-pass filter, a downconverter, and/or an analog-to-digital converter (A/D). A RF chain may contribute to a large portion of the receiver's total cost. One or more receive antennas may be coupled to a single RF chain at a receiver.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A method and/or system for channel estimation in an OFDM based MIMO system, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a diagram of an exemplary OFDM-based MIMO communication system that is operable to support channel estimation for multiple channels connected to a single RF chain, in accordance with an embodiment of the invention.

FIG. 2 is a block diagram illustrating an exemplary receiver that is operable to receive OFDM transmissions over multiple channels connected to a single RF chain, in accordance with an embodiment of the invention.

FIG. 3 is a block diagram illustrating an exemplary antenna calibration unit, in accordance with an embodiment of the invention.

FIG. 4 is a block diagram illustrating an exemplary channel estimator that is operable to generate individual channel estimates for multiple channels connected to a single RF chain, in accordance with an embodiment of the invention.

FIG. 5 is a block diagram illustrating an exemplary antenna weight generator that is operable to provide RF gain adjustment and phase rotation for each additional antenna coupled to a single RF chain, in accordance with an embodiment of the invention.

FIG. 6 is a flow chart illustrating exemplary steps to perform antenna combining for multiple receive antennas coupled to a single RF chain, in accordance with an embodiment of the invention.

FIG. 7 is a flow chart illustrating exemplary steps for determining gain adjustment and phase rotation for each additional antenna coupled to a single RF chain based on a combined channel estimate, in accordance with an embodiment of the invention.

### DETAILED DESCRIPTION OF THE INVENTION

Certain embodiments of the invention may be found in a method and system for channel estimation in an OFDM based MIMO system. In various embodiments of the invention, a receiver comprising a plurality of receive antennas operably coupled to a plurality of radio frequency (RF) chains is operable to receive spatially independent OFDM signals transmitted from a plurality of transmit antennas communicatively coupled to a single transmitter. In response, the receiver may be operable to adjust phase and/or gain of a portion of signal components of the received OFDM signals that are received over two or more receive antennas communicatively coupled to one of the plurality of RF chains. For a plurality of channels between the plurality of transmit antennas and the two or more receive antennas, a combined channel estimate may be generated using corresponding frequency domain samples of the phase and/or gain adjusted portion of signal components. The receiver is operable to generate an individual channel estimate for each of the plurality of channels between the transmit antennas and the two or more receive antennas communicatively coupled to the RF chain based on the generated combined channel estimate. One receive antenna coupled to the RF chain may be selected as a reference receive antenna for the RF chain. Phase rotation and/or gain adjustment information with respect to the selected reference receive antenna may be determined for each additional receive antenna coupled to the RF chain. The signal components received over each additional receive antenna coupled to the RF chain may be phase rotated and/or gain adjusted based on the corresponding determined phase rotation and/or gain adjustment information. The phase rotated and/or gain adjusted signal components may be combined with signal components received over the selected reference receive antenna for RF processing via the RF chain. The RF processed signal components may be converted into corresponding frequency domain samples to generate the combined channel estimate for the plurality of channels connected to the RF chain. Individual channel estimates related to the RF chain may be generated based on the generated combined channel estimate so as to determine the phase rotation and/or gain adjustment information for each additional receive antenna.

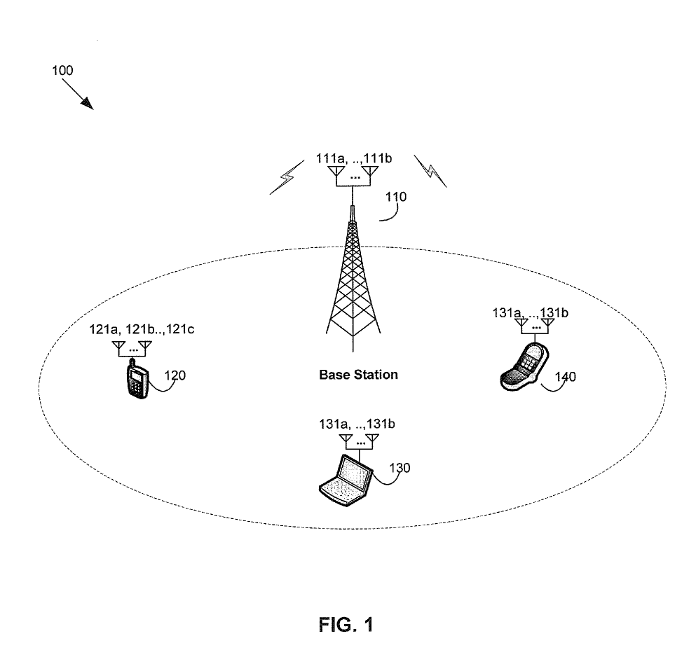

FIG. 1 is a diagram of an exemplary OFDM-based MIMO communication system that is operable to support channel estimation for multiple channels connected to a single RF chain, in accordance with an embodiment of the invention. Referring to FIG. 1, there is shown MIMO-OFDM communication system 100. The MIMO-OFDM communication system 100 comprises a base station 110 and a plurality of mobile devices, of which mobile devices 120-140 are illustrated.

The base station 110 may comprise suitable logic, circuitry, interfaces and/or code that may be operable to perform air interface processing and scheduling of communication resources such as frequencies and/or time slots in both uplink communications and downlink communications to various associated mobile devices such as the mobile device 120 in a timely manner. The base station 110 may be operable to determine which associated mobile device may receive a data packet and at what time the receiving should occur. In various embodiments of the invention, there may be concurrent communication between the base station 110 and a plurality of associated mobile devices such as the mobile devices 120-140. In this regard, the base station 110 may be operable to employ multiple available transmit antennas, for example, transmit antennas 111a-111b, to communicate multiple spatially independent data streams with one or more multi-antenna mobile devices such as the mobile devices 120-140. Multiple spatially independent data streams may be OFDM modulated and communicated to intended mobile devices over one or more single user downlink MIMO channels.

A single user downlink MIMO channel is formed by multiple transmit antennas located on the same base station such as the base station 110 and multiple receive antennas on a single mobile device such as the mobile device 120. For example, in instances where the base station 110 may be operable to utilize M available transmit antennas to transmit multiple spatially independent data streams to, for example, N receive antennas at the mobile device 120, a single user downlink MIMO channel between the base station 110 and the mobile device 120 comprises M×N spatial subchannels. The base station 110 may be operable to concurrently communicate M×N spatially independent data streams to the mobile device 120 over the single user downlink MIMO channel.

A multi-antenna mobile device such as the mobile device 120 may comprise suitable logic, circuitry and/or code that may be operable to communicate with a wireless communication network such as a long term evolution (LTE) communication network via the base station 110. The mobile device 120 may be operable to employ multiple available receive antennas, for example, the receive antennas 121a-121c, to concurrently receive OFDM signals comprising multiple spatially independent data streams from the base station 110. OFDM signal components received over the multiple receive antennas 212a-121c may be RF processed using a plurality of RF processing paths or RF chains. In this regard, multiple receive antennas such as the receive antennas 121a-121b may be coupled or connected to the same RF processing path or RF chain so as to reduce the overall receiver cost. OFDM signal components received over the multiple receive antennas coupled to the same RF chain may be weighted and then combined. In this regard, a receive antenna such as the receive antenna 121a may be selected as a reference receive antenna for remaining receive antennas such as the receive antenna 121b coupled to the same RF chain or RF processing path.

The OFDM signal components that are received over each of the remaining receive antennas may be weighted, for example, through phase rotation and/or gain adjustment. The resulting weighted OFDM signal components may be combined with OFDM signal components received over the selected reference receive antenna (the receive antenna 121a). The combined OFDM signal components may be RF processed using the same RF chain. The resulting RF processed OFDM signal components may be converted to corresponding frequency domain samples further baseband processing. In this regard, the mobile device 120 may be operable to perform channel estimation in frequency domain to generate a combined channel estimate. The generated combined channel estimate may indicate an average effect of multiple channels between the transmit antennas 111a-111b and the receive antennas 121a-121b. The generated combined channel estimate may be utilized to produce individual channel estimates for each channel between the transmit antennas 111a-111b and the receive antennas 121a-121b.

Although a channel estimate scheme for a single user downlink MIMO channel is discussed in FIG. 1, the invention may not be so limited. Accordingly, the channel estimate scheme may be applied to a channel estimate for an uplink MIMO channel without departing from the spirit and scope of various embodiments of the invention.

In an exemplary operation, a multi-antenna base station such as the base station 110 may be operable to concurrently communicate OFDM signals with a plurality of associated multi-antenna mobile devices such as the mobile devices 120-140. The communicated OFDM signals may comprise multiple spatially independent data streams. A mobile device such as the mobile device 120 may be configured to utilize multiple available receive antennas, for example, receive antennas 121a and 121b-121c, to concurrently receive OFDM signals from the base station 110. The receive antennas 121a and 121b-121c may be operable to convey received OFDM signal components to related RF chains for RF processing. In this regard, multiple receive antennas such as the receive antennas 121a-121b may be connected or coupled to a same RF chain. OFDM signal components received over the receive antennas 121a-121c may be RF processed using the same RF chain. The receive antenna 121a may be selected as a reference receive antenna. OFDM signals received over remaining receive antennas such as the receive antenna 121b may be weighted through phase rotation and/or gain adjustment. The weighted OFDM signal components may be combined with OFDM signal components received over the selected reference receive antenna (the receive antenna 121a). The combined OFDM signal components may be RF processed using the same RF chain. The RF processed OFDM signal components may be converted into frequency domain samples via a FFT operation.

The mobile device 120 may be operable to baseband process the corresponding frequency domain samples from each related RF chain. In instances where multiple receive antennas may be coupled to a same RF chain, the mobile device 120 may be operable to generate a combined channel estimate for channels between the multiple receive antennas and each available transmit antenna. Data streams in the received OFDM signals over the multiple receive antenna may be reconstructed using the generated combined channel estimate. Individual channel estimates for channels between each of the multiple receive antennas coupled to the same RF chain and available transmit antennas may be calculated from the generated combined channel estimate. The calculated individual channel estimates may be processed to provide antenna weight information such as phase rotation and/or gain adjustment utilized for weighting OFDM signal components received over each remaining receive antenna.

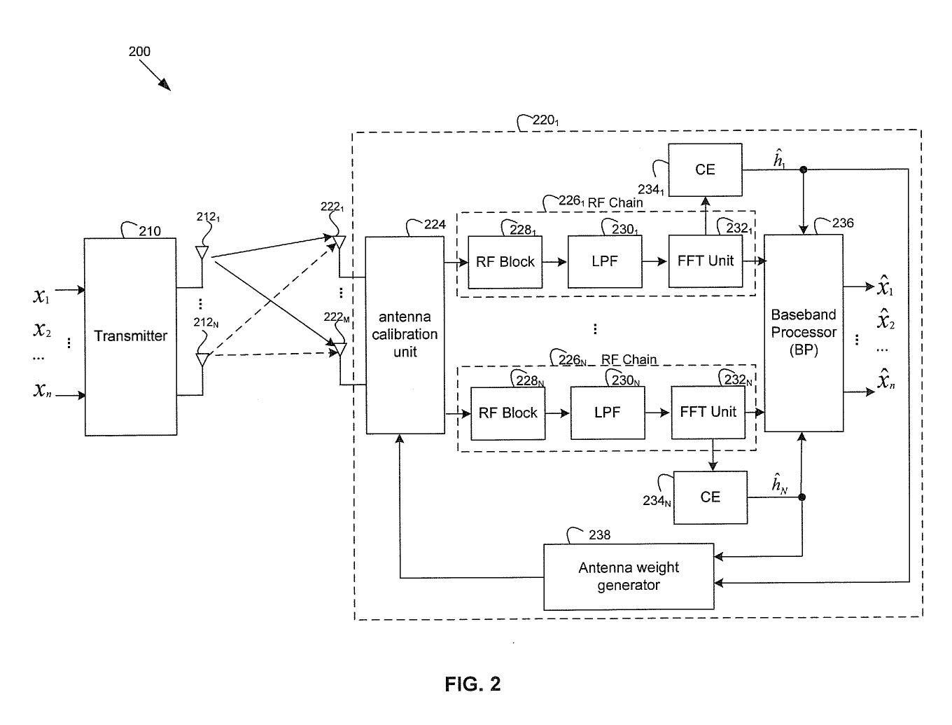

FIG. 2 is a block diagram illustrating an exemplary receiver that is operable to receive OFDM transmissions over multiple channels connected to a single RF chain, in accordance with an embodiment of the invention. Referring to FIG. 2, there is shown an MIMO-OFDM transmission system 200 comprising a transmitter 210 and a receiver 220.

On the transmit side, the transmitter 210 may comprise suitable logic, circuitry, interfaces and/or code that may be operable to process inputs, for example, x₁, x₂, . . . , x_{N}, for transmission. The transmitter 210 may be operable to OFDM modulate the inputs and separate the resulting OFDM signals into multiple spatially independent data streams. In instances where the transmitter 210 may be equipped with, for example, N available transmit antennas 212₁-212_{N}, where N is an integer and N>1, the transmitter 210 may be operable to separate the OFDM signals into at most N different spatially independent OFDM signals. In instances where an intended receiver such as the receiver 220 may be equipped with, for example, M receive antennas 222₁-222_{M}, where M is an integer and M>1, a single user MIMO channel between the transmitter 210 and the receiver 220 may comprise at most M×N spatial subchannels. The transmitter 210 may be operable to transmit to at most N spatially independent data streams via the transmit antennas 212₁-212_{N} over M×N spatial subchannels at a time.

A transmit antenna such as the transmit antenna 212₁ may comprise suitable logic, circuitry, interfaces and/or code that may be operable to transmit a spatially independent data stream. The transmit antenna 212₁ may be scheduled and/or assigned to transmit a spatially independent data stream to receive antennas of an intended receiver such as the receiver 220. In this regard, the transmit antenna 212₁ may be operable to transmit a spatially independent data stream over a plurality of channels between the transmitter 210 and the receiver 220. For example, the transmit antenna 212₁ may be operable to transmit a spatially independent data stream over spatial subchannels between the transmit antenna 212₁ and each of the receive antennas 222₁-222_{M}, respectively.

On the receive side, the receiver 220 comprises a plurality of receive antennas 222₁-222_{M}, an antenna calibration unit 224, a plurality of RF chains 226₁-226_{N}, a plurality of channel estimators 234₁-234_{N}, a baseband processor 236 and an antenna weight generator 238. Each RF chain comprises a RF block such as RF blocks 228₁-228_{N}, a low pass filter (LPF) such as LPF 230₁-230_{N}, a FFT unit such as FFT units 232₁-232_{N}. It may be assumed that the number of available receive antennas M is greater than the number of available RF chains, N, which is equal to the number of available transmit antennas on the transmitter 210.

A receive antenna such as the receive antenna 222₁ may comprise suitable logic, circuitry, interfaces and/or code that may be operable to receive OFDM signals comprising multiple spatially independent data streams. The receive antenna 222₁ may be scheduled and/or assigned to receive multiple spatially independent data streams from multiple available transmit antennas such as the transmit antennas 212₁-212_{N} located on the transmitter 210. In this regard, the receive antenna 222₁ may be operable to receive multiple spatially independent data streams over multiple spatial subchannels between the transmitter 210 and the antenna 222₁. Signal components received over the receive antennas 222₁-222_{M} may be communicated with the antenna calibration unit 224 for signal calibration and/or weighting prior to RF procession.

The antenna calibration unit 224 may comprise suitable logic, circuitry, interfaces and/or code that may be operable to calibrate signal components received over the receive antennas 222₁-222_{M}. In instances where a single receive antenna such as the receive antenna 222_{M} may be connected to a single RF chain such as the RF chain 226_{N}, the antenna calibration unit 224 may be operable to communicate signal components received over the receive antenna 222_{M} to the RF chain 226_{N} for RF process. In instances where multiple receive antennas such as the receive antennas 222₁-222₂ may be coupled to a same RF chain such as the RF chain 226₁, the antenna calibration unit 224 may be operable to select, for example, the receive antenna 222₁ as a reference receive antenna for the RF chain 226₁. Signal components received over each of the remaining receive antennas such as the receive antenna 222₂ may be calibrated or weighted. In this regard, the antenna calibration unit 224 may be operable to weight the received signal components over the receive antenna 222₂ by phase rotation and/or gain adjustment. The weighted signal components may be combined with signal components received over the selected reference receive antenna (the receive antenna 222₁). The combined signal components may be communicated to the RF chain 226₁ for RF process.

A RF chain such as the RF chain 226₁ may comprise suitable logic, circuitry, interfaces and/or code that may be operable to RF process OFDM signal components received over one or more receive antennas coupled to the RF chain 226₁

A RF block such as the RF block 228₁ may comprise suitable logic, circuitry, interfaces and/or code that may be operable to amplify and convert the analog RF signal components, which are received over one or more received antennas coupled to the RF chain 226₁, to digital baseband frequency signal components or samples. The RF block 228₁ may be operable to communicate the digital baseband frequency signal samples to the LPF 230₁ for further signal processing.

A LPF such as the LPF 230₁ may comprise suitable logic, circuitry, interfaces and/or code that may be operable to filter the digital baseband signal samples from the RF block 228₁ and to produce complex in-phase and quadrature components (I, Q) of the LPF filtered OFDM signal components.

A FFT unit such as the FFT unit 232₁ may comprise suitable logic, circuitry, interfaces and/or code that may be operable to perform fast Fourier transform (FFT) over LPF filtered OFDM signal components from the LPF 230₁. The FFT unit 232₁ may be operable to convert time domain samples of the LPF filtered OFDM signal components to corresponding frequency domain samples for frequency domain channel estimation via the channel estimator 234₁.

A channel estimator such as the channel estimator 234₁ may comprise suitable logic, circuitry, interfaces and/or code that may be operable to estimate channel conditions in frequency domain for channels related to one or more receive antennas coupled to the RF chain 226₁. In instances where multiple receive antennas such as the receive antennas 222₁-222₂ are coupled to a same RF chain such as the RF chain 226₁, the channel estimator 234₁ may be operable to receive combined signal components for the multiple receive antennas, for example, the receive antennas 222₁-222₂, coupled to the same RF chain. The channel estimator 234₁ may be operable to generate a combined channel estimate for the multiple channels related to the RF chain 226₁. The channel estimator 234₁ may be operable to communicate the generated combined channel estimate to the baseband processor 236 and the antenna weight generator 238, respectively.

The baseband processor 236 may comprise suitable logic, circuitry, interfaces and/or code that may be operable to perform various baseband processes such as, for example, channel decoding, on OFDM signal frequency samples from each of the RF chains 226₁-226_{N}. The baseband processor 236 may be operable to reconstruct transmitted data streams using the corresponding OFDM signal frequency samples from the RF chains 226₁-226_{N}.

The antenna weight generator 238 may comprise suitable logic, circuitry, interfaces and/or code that may be operable to generate antenna weight information such as, for example, phase rotation and/or gain adjustment, for each receive antenna based on channel estimates from the CEs 234₁-234_{N}. In instances where multiple receive antennas such as the 222₁-222₂ may be coupled to a same RF chain such as the RF chain 226₁, the antenna weight generator 238 may be operable to generate phase rotation and gain adjustment information utilized for weighting signal components received over remaining receive antennas such as the receive antenna 222₂ coupled to the same RF chain (the RF chain 226₁).

In an exemplary operation, a plurality of signals such as x₁, x₂, . . . , x_{N} to be transmitted may be OFDM modulated. The resulting OFDM signals may be separated into multiple spatially independent data streams for transmission. The transmit antennas 212₁-212_{N} located on the transmitter 210 may be configured to transmit the multiple spatially independent data streams. In instances where a receiver such as the receiver 220 may be selected to receive at least a portion of the multiple spatially independent data streams, each of the receive antennas 222₁-222_{M} may be scheduled and/or assigned to receive spatially independent data streams from available transmit antennas on the transmitter 210. In instances where multiple receive antennas such as the receive antennas 222₁-222₂ may be coupled to a same RF chain such as the RF chain 226₁, OFDM signal components received over the receive antennas 222₁-222₂ may be weighted via the antenna calibration unit 224.

The antenna calibration unit 224 may be operable to select, for example, the receive antenna 222₁ as a reference receive antenna for the RF chain 226₁, OFDM signal components received over the receive 222₂ may be weighted, for example, by phase rotating and gain adjusting. The weighted OFDM signal components may be combined with OFDM signal components received over the selected reference receive antenna, that is, the receive antenna 222₁. The resulting combined OFDM signal components may be RF processed over the RF chain 226₁. The RF block 228₁ may be operable to amplify and convert the combined OFDM signal components to corresponding digital baseband OFDM signal components. The LPF 230₁ may be operable to low-pass the digital baseband OFDM signal components. The resulting low-pass filtered digital baseband OFDM signal components may be converted into corresponding frequency domain samples via the FFT unit 232₁. The channel estimator 234₁ may be operable to perform channel estimation for combined channels between the transmit antennas 212₁-212_{N} and the receive antennas 222₁-222₂ that are coupled to the RF chain 226₁. Each RF chain may communicate corresponding channel estimates to the baseband processor 236 and the antenna weight generator 238, respectively.

The baseband processor 236 may be operable to reconstruct corresponding transmitted data streams in the received OFDM signals based on channel estimates from the CEs 234₁-234_{N}. For each RF chain such as the RF chain 226₁, the antenna weight generator 238 may be configured to generate an individual channel estimates for channels between available transmit antennas such as the transmit antennas 212₁-212_{N} located on the transmitter 210 and each receive antenna coupled to the RF chain 226₁. The generated individual channel estimates for, for example, a channel between the transmit antennas 212₁ and the receive antenna 222₁, may be utilized to derive antenna weight information such as phase rotation and/or gain adjustment related to the receive antenna 222₁.

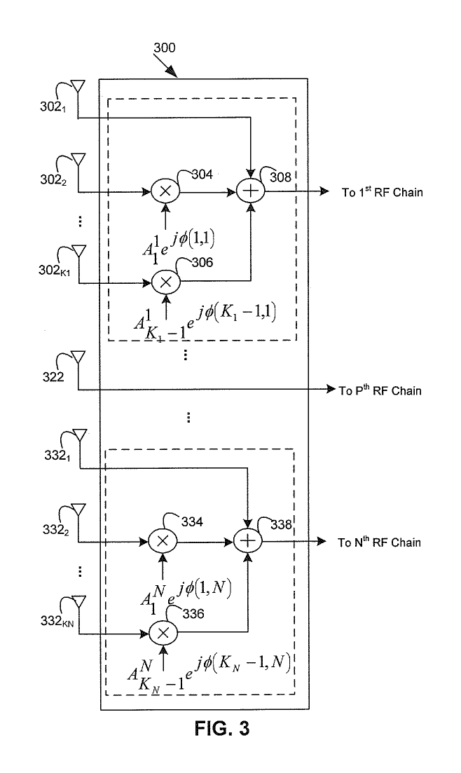

FIG. 3 is a block diagram illustrating an exemplary antenna calibration unit, in accordance with an embodiment of the invention. Referring to FIG. 3, there is shown an antenna calibration unit 300.

The antenna calibration unit 300 may comprise suitable logic, circuitry, interfaces and/or code that may be operable to calibrate radio frequency signals received. The antenna calibration unit 300 is connected between a plurality of receive antennas, of which receive antennas 302₁-302_{K1}, 322, and 332₁-332_{KN} are illustrated, and N available RF chains, where N is integer and N≧1, K₁-K_{N} are number of receive antennas coupled to the 1^{st}-N^{th} RF chain and K₁-K_{N} are integers and K₁-K_{N}≧1. Depending on implementation, one or more receive antennas may be coupled to a single RF chain. For example, the receive antennas 302₁-302_{K1} are coupled to the first RF chain, where K₁ is an integer and K₁>1. In instances where a single receive antenna such as the receive antenna 322 is coupled to a single RF chain such as the p^{th} RF chain, where p is an integer and 1<p<N, the antenna calibration unit 300 may be operable to directly convey OFDM signal components received over the receive antenna 322 to the p^{th} RF chain for RF processing. In instances where multiple receive antennas such as the receive antennas 302₁-302_{K1} are coupled to a single RF chain such as the first RF chain, the antenna calibration unit 300 may be operable to provide a combination or superposition of OFDM signal components received over the receive antennas 302₁-302_{K1} to the first RF chain for RF processing. In this regard, a receive antenna such as the receive antenna 302₁ may be selected as a reference receive antenna for the first RF chain. The OFDM signal components received over each additional or remaining receive antenna such as the receive antennas 302₂-302_{K1} coupled to the first RF chain are weighted via multipliers 304-306 and then combined via a combiner 308. The resulting combined signal components may be communicated to the first RF chain for RF processing.

A multiplier such as the multiplier 304 may comprise suitable logic, circuitry, interfaces and/or code that may be operable to multiply and/or weight OFDM signal components received over each additional receive antenna coupled to first RF chain with a complex weight comprising gain adjustment and phase rotation. The weighted OFDM signal components from the multipliers 304-306 may be communicated to a combiner 308.

A combiner such as the combiner 308 may comprise suitable logic, circuitry, interfaces and/or code that may be operable to combine weighted OFDM signal components from the multipliers 304-306 with OFDM signal components received over the selected reference receive antenna (the receive antenna 302₁). The resulting combined OFDM signal components may be RF processed using the first RF chain. The RF processed OFDM signal components may be converted into corresponding baseband frequency domain samples for baseband processing.

In an exemplary operation, multiple receive antennas such as the receive antennas 302₁-302_{K1} may be coupled to the first RF chain of the receiver 220. One of the multiple receive antenna, for example, the receive antenna 302₁ may be selected as a reference receive antenna. OFDM signal components received over each of the additional receive antennas such as the receive antennas 302₂-302_{K1} coupled to the first RF chain may be weighted via the multipliers 304-306 for phase rotation and/or gain adjustment. The resulting weighted OFDM signal components may be combined via the combiner 308 with OFDM signal components received over the selected reference receive antenna (the receive antenna 302₁). The resulting combined OFDM signal components may be RF processed using the first RF chain of the receiver 220 for further baseband processing.

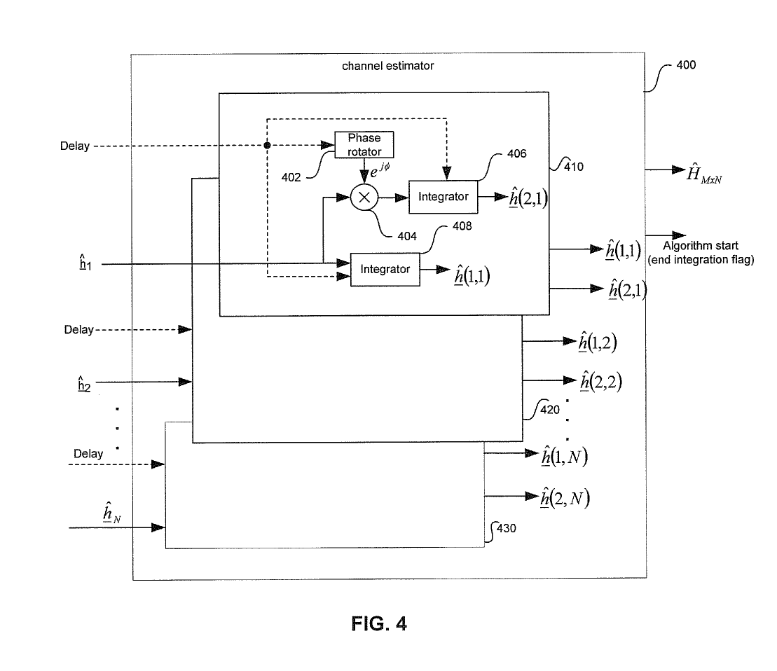

FIG. 4 is a block diagram illustrating an exemplary channel estimator that is operable to generate individual channel estimates for multiple channels connected to a single RF chain, in accordance with an embodiment of the invention. Referring FIG. 4, there is shown a channel estimator 400. The channel estimator 400 comprises a plurality of channel processors, of which channel processors 410-430 are illustrated.

The transmitter such as the transmitter 210 may be operable to utilize N, where N is an integer and N≧1, available transmit antennas for data transmissions to an intended receiver such as the receiver 220. The receiver 220 may be operable to utilize M, where M is an integer and M≧N, available receive antennas to receive transmissions from the transmitter 210. The receiver 220 may comprise N RF chains utilized for RF processing the received transmissions from the N transmit antennas on the transmitter 210. The channel estimate matrix of a single user MIMO channel between the N transmit antennas on the transmitter 210 and the M receive antennas on the receiver 220 may be expressed as following:

$${H}_{M \times N} = [ \begin{matrix}\hat{h} ( 1 , 1 ) , & \hat{h} ( 1 , 2 ) , … , & \hat{h} ( 1 , N ) \\ \hat{h} ( 2 , 1 ) , & h ( 2 , 2 ) , … , & \hat{h} ( 2 , N ) \\ … & & \\ \hat{h} ( M , 1 ) , & h ( M , 2 ) , … , & \hat{h} ( M , N )\end{matrix} ]$$

where h(i,j), 1≦i≦M, 1≦j≦N, is a channel estimate for a spatial subchannel between the ith transmit antenna located on the transmitter 210 and the jth receive antenna on the receiver 220. OFDM signal components received over the M available receive antennas on the receiver 220 may be expressed utilizing the following relationship:

$${r}_{M \times N} = [ \begin{matrix}r ( 1 , 1 ) , & r ( 1 , 2 ) , … , & r ( 1 , N ) \\ r ( 2 , 1 ) , & r ( 2 , 2 ) , … , & r ( 2 , N ) \\ … & & \\ r ( M , 1 ) , & r ( M , 2 ) , … , & r ( M , N )\end{matrix} ] ,$$

where r(i,j), 1≦i≦M, 1≦j≦N, is the input signal components received over the spatial subchannel h(i,j) to the receiver 220. The received OFDM signal components r_{M×N} may be RF processed via the N RF chains.

A channel processor is assigned to a particular RF chain of the receiver 220. A channel processor such as the channel processor 410 may comprise a phase rotator 402, a multiplier 404, and integrators 406-408. As an example, it may be assumed that two receive antennas may be coupled to each of the N RF chains.

The channel processor 410 may comprise suitable logic, circuitry, interfaces and/or code that may be operable to generate a channel estimate for each individual channel between the N transmit antennas and the two receive antennas coupled to the first RF chain.

The phase rotator 402 may comprise suitable logic, circuitry, interfaces and/or code that may be operable to generate a phase rotation or adjustment value for each additional receive antenna coupled to the first RF chain. The phase rotation value may be generated based on delay information on a corresponding individual spatial subchannel, that is h(2,1), between the second receive antenna and the first transmit antenna.

The multiplier 404 may comprise suitable logic, circuitry, interfaces and/or code that may be operable to multiply a combined channel estimate ĝ₁ related to the first RF chain with the generated phase rotation value from the phase rotator 402. The combined channel estimate ĥ₁ is a channel estimate for channels between the first transmit antenna and two receive antennas coupled to the first RF chain.

An integrator such as the integrator 404 may comprise suitable logic, circuitry, interfaces and/or code that may be operable to generate a channel estimate for an individual channel between the first transmit antenna and a specific receive antenna coupled to the first RF chain. For example, in instances where the first receive antenna coupled to the first RF chain may be selected as a reference receive antenna, the integrator 406 may be operable to generate a channel estimate ĥ(2,1) for an individual channel between the first transmit antenna and the second receive antenna coupled to the first RF chain. The integrator 408 may be operable to generate an individual channel estimate ĥ(1,1) for an individual channel between the first transmit antenna and the first receive antenna (the selected reference receive antenna) coupled to the first RF chain. Similarly, individual channel estimates related to the combined channel estimates ĥ₂ . . . ĥ_{N} may be determined. The combined channel estimate estimates ĥ₂ . . . ĥ_{N} in time may be derived from consecutive OFDM channel estimation symbols. For an OFDM system, channel estimates may be determined at each frequency. The generated individual channel estimates associated with each of the N RF chains may be utilized to generate antenna weight information to be used for subsequently receiving OFDM signal components over, for example, the two receive antennas coupled to corresponding RF chains.

In an exemplary operation, a combined channel estimate, for example, ĥ₁, for channels between the first transmit antenna and each of the two receive antennas coupled to the first RF chain, may be expressed as ĥ₁=ĥ(1,1)+e^{jφ}h(2,1), where φ is the phase rotation or adjustment value applied to OFDM signal components received over the second receive antenna coupled to the first RF chain. An individual channel estimate for a channel between the first transmit antenna to the first receive antenna coupled to the first RF chain may be determined by taking an expected value or integration of ĥ₁ over [φ:0,2π] so that an individual channel estimate for a channel between the first transmit antenna to the first receive antenna coupled to the first RF chain may be determined by the following expression:

ĥ(1,1)=E(ĥ₁)=E(ĥ(1,1)+e^{jφ}ĥ(2,1))=ĥ(1,1)+E(e^{jφ}ĥ(2,1)), where E(e^{jφ}ĥ(2,1))=0 for [φ:0,2π].

An individual channel estimate for a channel between the first transmit antenna to the second receive antenna coupled to the first RF chain may be determined by the following expression:

ĥ(2,1)=E(e^{-jφ}ĥ₁)=E(e^{-jφ}ĥ(1,1)+ĥ(2,1))=E(e^{-jφ}ĥ(1,1))+ĥ(2,1),

where E(e^{-jφ}ĥ(1,1))=0 for [φ:0,2π]. Following this example, individual channel estimates related to the combined channel estimates ĥ₂ . . . ĥ_{N} may be determined.

The combined and individual channel estimates may be determined utilizing a plurality of available consecutive time samples. In this regard, a full rotation of [φ:0,2π] may be utilized. In instances where a limited number of consecutive time samples are available for determining the combined and individual channel estimates, corresponding phase rotation values may be discrete values. For example, in instances where only two time samples are available for determining the combined and individual channel estimates, phase rotation values of φ=0 and φ=π may be applied for the first and the second sample phase values, respectively. In addition, channel estimates in an OFDM system may be determined or derived at each frequency.

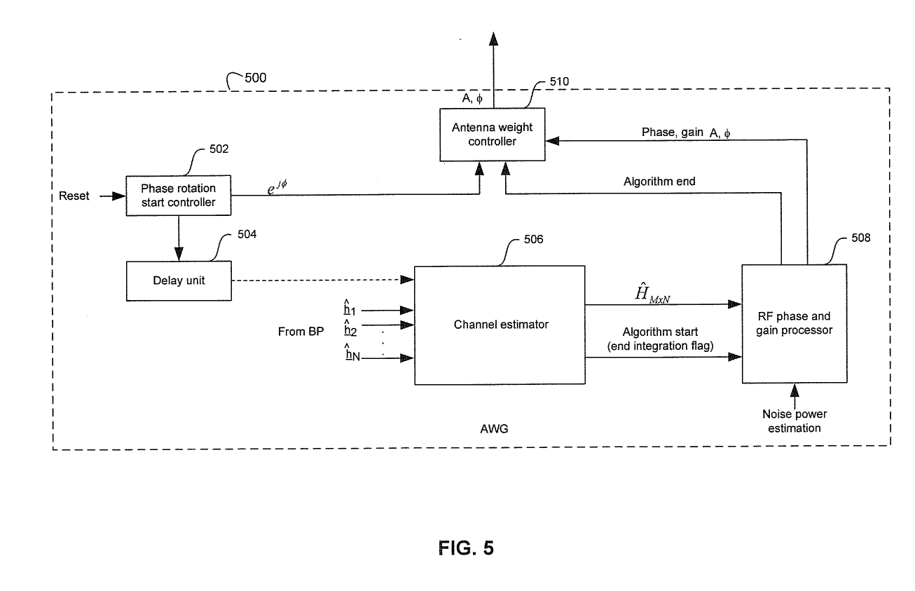

FIG. 5 is a block diagram illustrating an exemplary antenna weight generator that is operable to provide RF gain adjustment and phase rotation for each additional antenna coupled to a single RF chain, in accordance with an embodiment of the invention. Referring to FIG. 5, there is shown an antenna weight generator (AWG) 500 comprising a phase rotation start controller 502, a delay unit 504, a channel estimator 506, a RF phase and gain processor 508, and an antenna weight controller 510.

The phase rotation or adjustment start controller 502 may comprise suitable logic, circuitry, interfaces and/or code that may be operable to trigger or initiate the start of phase rotation on OFDM signal components received over a receive antenna. The phase rotation start controller 502 may be operable to initiate the phase rotation or adjustment on OFDM signal components receiver over the receive antenna after receiving a reset signal. The phase rotation start controller 502 may be operable to signal the delay unit 504 and the antenna weight controller 510 for starting the phase rotation or adjustment operation on OFDM signal components received over the receive antenna.

The delay unit 504 may comprise suitable logic, circuitry, interfaces and/or code that may be operable to generate a delay signal based on the phase rotation or adjustment signaling from the phase rotation start controller 502. The generated delay signal relates to phase rotation or adjustment information applied to each individual channel connected to the receive antenna. The generated delay signal may be communicated with the channel estimator 506.

The channel estimator 506 may comprise suitable logic, circuitry, interfaces and/or code that may be operable to generate individual channel estimates for channels between the transmitter 210 and the receiver 220. In instances where multiple receive antennas may be coupled to a single RF chain of the receiver 220, the channel estimator 506 may be operable to generate individual channel estimates for channels between the transmitter 210 and each receive antenna coupled to the single RF chain of the receiver 220. The generated individual channel estimates may be communicated to the RF phase and gain processor 508.

The RF phase and gain processor 508 may comprise suitable logic, circuitry, interfaces and/or code that may be operable generate phase rotation or adjustment, and gain adjustment information that may be used to weight OFDM signal components received over specific receive antennas. The RF phase and gain processor 508 may be operable to determine phase rotation or adjustment, and gain adjustment information for the specific receive antennas based on related individual channel estimates, noise power level, and/or phase rotation or adjustment start/end signaling. The generated phase rotation or adjustment, and gain adjustment information for the specific receive antennas may be communicated to the antenna weight controller 510.

The antenna weight controller 510 may comprise suitable logic, circuitry, interfaces and/or code that may be operable to manage and control the utilization of the generated phase rotation and gain information from the RF phase and gain processor 508 for weighting OFDM signal components received over specific receive antennas. The antenna weight controller 510 may be operable to start or end the antenna weighting operation based on signaling from the phase rotation start controller 503 and the RF phase and gain processor 508.

In an exemplary operation, the phase rotation start controller 502 may be operable to signal the delay unit 504 and the antenna weight controller 510 for the start of phase rotation on OFDM signal components received over specific receive antennas on the receiver 220. The delay unit 504 may be operable to generate a delay signal for each individual channel. The channel estimator 506 may be operable to generate individual channel estimates for channels connected to each receive antenna coupled to RF chains of the receiver 220. The RF phase and gain processor 508 may be operable to generate phase rotation and gain adjustment information for each receive antenna on the receiver 220 based on related individual channel estimates. The antenna weight controller 510 may be configured to manage and control antenna weighting operation using the generated phase rotation and gain adjustment information from the RF phase and gain processor 508.

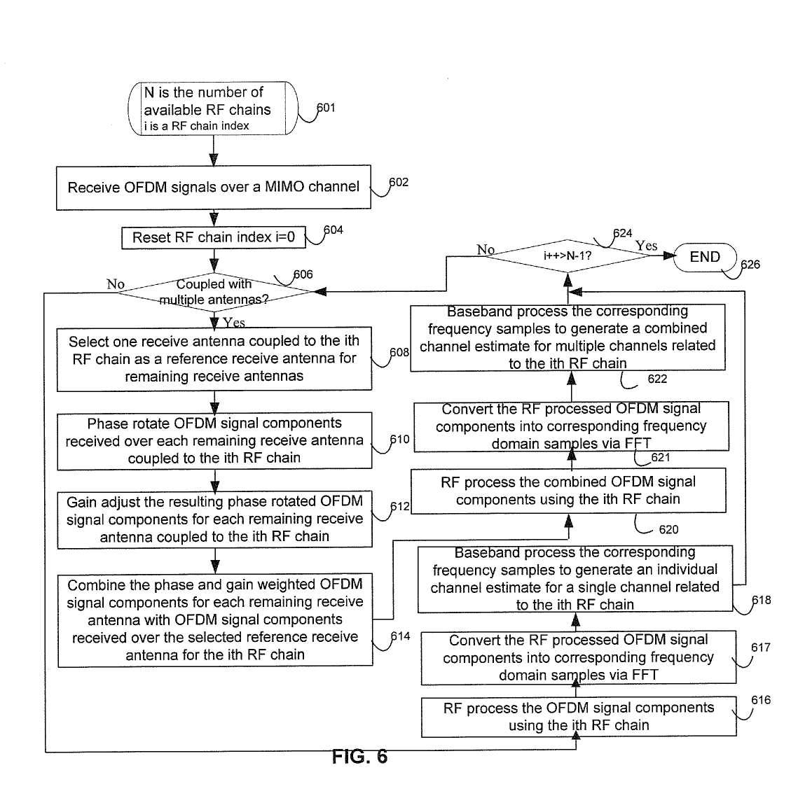

FIG. 6 is a flow chart illustrating exemplary steps to perform antenna combining for multiple receive antennas coupled to a single RF chain, in accordance with an embodiment of the invention. The exemplary steps start with step 601, where the receiver 220 comprise N available RF chains, where N is an integer and N>1. The parameter i is an RF chain index. In step 602, the receiver 220 may be operable to receive OFDM signals over a single user MIMO channel from the transmitter 210. In step 604, the RF chain index i is reset to 0 for processing the received OFDM signals. In step 606, it may be determined that whether the ith RF chain is coupled with multiple receive antennas. In instances where multiple receive antennas may be coupled to the i^{th} RF chain, then step 608.

In step 608, one receive antenna coupled to the i^{th} RF chain may be selected as a reference receive antenna for remaining receive antennas. In step 610, the receiver 220 may be operable to phase rotate or adjustment OFDM signal components received over each remaining receive antenna coupled to the ith RF chain. In step 612, the phase rotated OFDM signal components may be gain adjusted. In step 614, the receiver 220 may be operable to combine the phase and gain weighted OFDM signal components with OFDM signal components received over the selected reference receive antenna. In step 620, the receiver 220 may be operable to RF process the combined OFDM signal components using the ith RF chain. In step 621, the receiver 220 may be operable to convert the RF processed OFDM signal components into corresponding frequency domain samples using FFT. In step 622, the receiver 220 may be operable to baseband process the corresponding frequency domain samples of the RF processed OFDM signal components to generate a combined channel estimate for multiple channels related to the ith RF chain. In step 624, the RF chain index is increase by a step of 1. It may be determined whether the updated RF chain index is greater than N−1. In instances where the updated RF chain index is greater than N−1, the exemplary steps may end in step 626.

In step 604, in instances where no multiple receive antennas may be coupled to the ith RF chain, then step 616. In step 616, the receiver 220 may be operable to RF process OFDM signal components using the ith RF chain. In step 617, the receiver 220 may be operable to convert the RF processed OFDM signal components into corresponding frequency domain samples using FFT. In step 618, the receiver 220 may be operable to baseband process the corresponding frequency domain samples of the RF processed OFDM signal components to generate an individual channel estimate for each individual channel related to the ith RF chain. The exemplary steps may proceed in step 624. In step 624, in instances where the updated RF chain index is less than or equal to N−1, the exemplary steps may return to step 606.

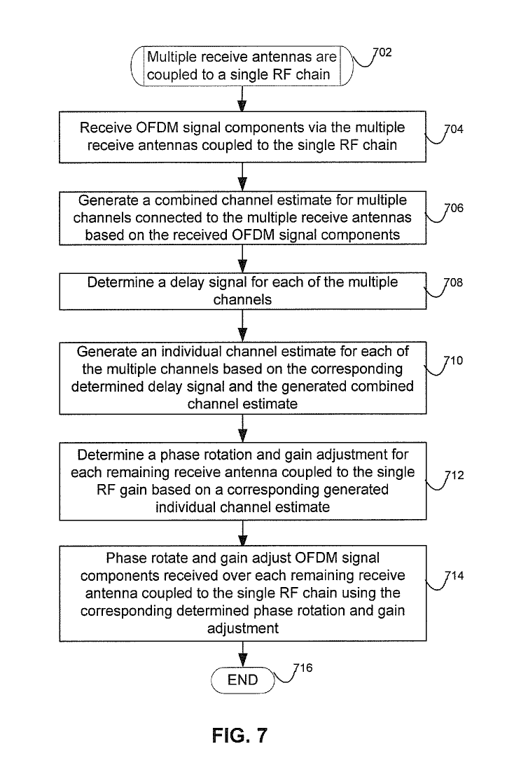

FIG. 7 is a flow chart illustrating exemplary steps for determining gain adjustment and phase rotation for each additional antenna coupled to a single RF chain based on a combined channel estimate, in accordance with an embodiment of the invention. The exemplary steps start with step 702, where the receiver 220 comprise N available RF chains, where N is an integer and N>1. The receiver 200 comprises at least one RF chain connected with multiple receive antennas. In step 704, the multiple receive antennas coupled to the same RF chain may be operable to receive OFDM signal components from multiple transmit antennas on the transmitter 210. In step 706, the receiver 220 may be operable to generate a combined channel estimate for multiple channels between the multiple transmit antennas on the transmitter 210 and multiple receive antennas coupled to the same RF chain of the receiver 220. The combined channel estimate is generated based on the received OFDM signal components. In step 708, a delay signal may be determined for each of the multiple channels.

In step 710, the receiver 220 may be operable to generate an individual channel estimate for each of the multiple channels based on the corresponding determined delay signal and the generated combined channel estimate. In step 712, a phase rotation and gain adjustment may be determined for each remaining receive antenna coupled to the single RF gain based on a corresponding generated individual channel estimate. In step 714, the receiver 220 may be operable to phase rotate and gain adjust OFDM signal components received over each remaining receive antenna coupled to the single RF chain using the corresponding determined phase rotation and gain adjustment. The exemplary steps may end in step 716.

Exemplary aspects of a method and system for channel estimation in an OFDM based MHO system are provided. In accordance with various embodiments of the invention, a receiver such as the receiver 220 comprises a plurality of receive antennas such as the receive antennas 222₁-222_{M} coupled to a plurality of radio frequency (RF) chains such as the RF chains 226₁-226_{N}. The number of the receive antennas is greater than the number of RF chains. The receiver 220 may be operable to receive spatially independent OFDM signals, via, for example, the receive antennas 222₁-222_{M}, the spatially independent OFDM signals are transmitted from a plurality of transmit antennas such as the transmit antennas 212₁-212_{N} operably coupled to a single transmitter such as the transmitter 210. In response, the receiver 220 may be operable to adjust phase and/or gain of a portion of signal components of the received OFDM signals. The portion of signal components are received over two or more receive antennas such as the receive antennas 302₁-302_{K1} communicatively coupled to one of the plurality of RF chains, for example, the RF chain 226₁. For a plurality of channels between the transmit antennas 212₁-212_{N} and said two or more receive antennas, for example, the receive antennas 302₁-302_{K1}, communicatively coupled to the RF chain 226₁, the receiver 220 may be operable to generate a combined channel estimate, utilizing corresponding frequency domain samples of the phase and/or gain adjusted portion of signal components of the received OFDM signals. An individual channel estimate for each of the multiple channels between the transmit antennas 212₁-212_{N} and the receive antennas 302₁-302_{K1} communicatively coupled to the RF chain 226₁ may be generated based on the generated combined channel estimate. One of the receive antennas 302₁-302_{K1} coupled to the RF chain 226₁, for example, the first coupled receive antenna 302₁, may be selected as a reference receive antenna for the RF chain 226₁.

The antenna weight generator 238 may be operable to determine phase rotation and/or gain adjustment information with respect to the selected reference receive antenna, that is the receive antenna 302₁, for each additional receive antenna coupled to the RF chain 226₁. The antenna calibration unit 224 may be operable to perform phase rotation and/or gain adjustment on the portion of signal components received over each additional receive antenna coupled to the RF chain 226₁ based on the corresponding determined phase rotation and/or gain adjustment information from the antenna weight generator 238. The phase rotated and/or gain adjusted signal components may be combined via the combiner 308, for example, with the portion of signal components of the received OFDM signals received over the selected reference receive antenna, that is the receive antenna 302₁. The receiver 220 may be operable to RF process the combined signal components using the RF chain 226₁. The RF processed signal components may be converted, for example, via the FFT unit 232₁, into corresponding frequency domain samples. The CE 234₁ may be operable to generate the combined channel estimate for the plurality of channels between the transmit antennas 212₁-212_{N} and the receive antennas 302₁-302_{K1} coupled to the RF chain 226₁ based on the resulting frequency domain samples. The channel estimator 400 may be operable to generate an individual channel estimate for each of the plurality of channels between the transmit antennas 212₁-212_{N} and the receive antennas 302₁-302_{K1} coupled to the RF chain 226₁ based on the generated combined channel estimate. The RF phase and gain processor 508 may be operable to determine the phase rotation and/or gain adjustment information with respect to the selected reference receive antenna for each additional receive antenna, that is the receive antennas 302₂-302_{K1}, coupled to the RF chain 226₁ based on the generated corresponding individual channel estimate.

Other embodiments of the invention may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps as described herein for channel estimation in an OFDM based MIMO system.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for processing signals in a communication system, the method comprising:
performing by one or more processors and/or circuits in a receiver, wherein said receiver comprises a plurality of receive antennas operably coupled to a plurality of radio frequency (RF) chains:
receiving spatially independent Orthogonal Frequency Division Multiplexing (OFDM) signals, via said plurality of receive antennas, wherein said spatially independent OFDM signals are transmitted from a plurality of transmit antennas communicatively coupled to a single transmitter;
adjusting phase and/or gain of a portion of signal components of said received OFDM signals, wherein said portion of said signal components are received via two or more receive antennas communicatively coupled to one of said plurality of RF chains;
for a plurality of channels between said plurality of transmit antennas and said two or more receive antennas communicatively coupled to said one of said plurality of RF chains, generating a combined channel estimate utilizing corresponding frequency domain samples of said phase and/or gain adjusted portion of signal components of said received OFDM signals; and
generating an individual channel estimate for each of said plurality of channels based on said generated combined channel estimate.

2. The method according to claim 1, comprising selecting one of said two or more receive antennas coupled to said one of said plurality of RF chains as a reference receive antenna for said one of said plurality of RF chains.

3. The method according to claim 2, comprising determining phase rotation and/or gain adjustment information with respect to said selected reference receive antenna for each additional receive antenna coupled to said one of said plurality of RF chains.

4. The method according to claim 3, comprising phase rotating and/or gain adjusting said portion of said signal components of said received OFDM signals over said each additional receive antenna coupled to said one of said plurality of RF chains based on said corresponding determined phase rotation and/or gain adjustment information.

5. The method according to claim 4, comprising combining said phase rotated and/or gain adjusted signal components with said portion of said signal components of said received OFDM signals over said selected reference receive antenna.

6. The method according to claim 5, comprising RF processing said combined signal components using said one of said plurality of RF chains.

7. The method according to claim 6, comprising converting said RF processed signal components into corresponding frequency domain samples.

8. The method according to claim 7, comprising generating said combined channel estimate for said plurality of channels based on said resulting frequency domain samples.

9. The method according to claim 8, comprising generating an individual channel estimate for each of said plurality of channels based on said generated combined channel estimate.

10. The method according to claim 9, comprising determining said phase rotation and/or gain adjustment information with respect to said selected reference receive antenna for said each additional receive antenna coupled to said one of said plurality of RF chains based on said generated corresponding individual channel estimate.

11. A system for signal processing, the system comprising:
one or more processors and/or circuits for use within a receiver, wherein said receiver comprises a plurality of receive antennas operably coupled to a plurality of radio frequency (RF) chains, said one or more processors and/or circuits being operable to:
receive spatially independent Orthogonal Frequency Division Multiplexing (OFDM) signals, via said plurality of receive antennas, wherein said spatially independent OFDM signals are transmitted from a plurality of transmit antennas communicatively coupled to a single transmitter;
adjust phase and/or gain of a portion of signal components of said received OFDM signals, wherein said portion of said signal components are received via two or more receive antennas communicatively coupled to one of said plurality of RF chains;
for a plurality of channels between said plurality of transmit antennas and said two or more receive antennas communicatively coupled to said one of said plurality of RF chains, generate a combined channel estimate utilizing corresponding frequency domain samples of said phase and/or gain adjusted portion of signal components of said received OFDM signals; and
generate an individual channel estimate for each of said plurality of channels based on said generated combined channel estimate.

12. The system according to claim 11, wherein said one or more processors and/or circuits are operable to select one of said two or more receive antennas coupled to said one of said plurality of RF chains as a reference receive antenna for said one of said plurality of RF chains.

13. The system according to claim 12, wherein said one or more processors and/or circuits are operable to determine phase rotation and/or gain adjustment information with respect to said selected reference receive antenna for each additional receive antenna coupled to said one of said plurality of RF chains.

14. The system according to claim 13, wherein said one or more processors and/or circuits are operable to phase rotate and/or gain adjust said portion of said signal components of said received OFDM signals over said each additional receive antenna coupled to said one of said plurality of RF chains based on said corresponding determined phase rotation and/or gain adjustment information.

15. The system according to claim 14, wherein said one or more processors and/or circuits are operable to combine said phase rotated and/or gain adjusted signal components with said portion of said signal components of said received OFDM signals over said selected reference receive antenna.

16. The system according to claim 15, wherein said one or more processors and/or circuits are operable to RF process said combined signal components using said one of said plurality of RF chains.

17. The system according to claim 16, wherein one or more processors and/or circuits are operable to convert said RF processed signal components into corresponding frequency domain samples.

18. The system according to claim 16, wherein one or more processors and/or circuits are operable to generate said combined channel estimate for said plurality of channels based on said resulting frequency domain samples.

19. The system according to claim 16, wherein one or more processors and/or circuits are operable to generate an individual channel estimate for each of said plurality of channels based on said generated combined channel estimate.

20. The system according to claim 19, wherein one or more processors and/or circuits are operable to determine said phase rotation and/or gain adjustment information with respect to said selected reference receive antenna for said each additional receive antenna coupled to said one of said plurality of RF chains based on said generated corresponding individual channel estimate.
